(19) United States
(12) Patent Application Publication
(10) Pub. No.: US 2026/0100080 A1
(43) Pub. Date: Apr. 9, 2026

(54) Offline mode NFC-based FIDO2 Authentication System for Door/Turnstile Access Control

(71) Applicants: Shashi Prakash Singh, Aalsmeer (NL); Khyber Matin, Assendelft (NL)

(72) Inventors: Shashi Prakash Singh, Aalsmeer (NL); Khyber Matin, Assendelft (NL)

(21) Appl. No.: 18/908,797

(22) Filed: Oct. 8, 2024

(51) Int. Cl. G07C 9/00; H04W 12/47

(52) U.S. Cl. CPC G07C 9/00309; H04W 12/47; G07C 2009/00388

(57) ABSTRACT

The present invention relates to an offline mode Near Field Communication (NFC)-based FIDO2 authentication system for door and turnstile access control. This system comprises a FIDO2 security key, an NFC reader, and a door controller. The FIDO2 security key stores user credentials and performs cryptographic operations, while the NFC reader communicates with the key to authenticate users. The door controller, connected to the NFC reader, controls the door lock mechanism based on authentication results. The system operates without continuous network connectivity, providing secure offline authentication. The NFC reader performs several operations: it receives credential data from the FIDO2 security key, generates and transmits a cryptographic challenge, receives and verifies a signed response using a pre-stored public key, extracts a Physical Access Control (PAC) number upon successful authentication, and transmits the PAC number to the door controller to grant or deny access.

### CROSS-REFERENCE TO RELATED APPLICATIONS

No related applications are previously filed.

### FIELD OF THE INVENTION

The present invention relates generally to access control systems, and more specifically to an offline Near Field Communication (NFC)-based authentication system that leverages FIDO2 cryptographic security protocols for securing physical access to doors and turnstiles. The invention addresses significant security vulnerabilities in existing NFC-based access systems and introduces a novel solution that operates in offline environments, where internet connectivity is limited or non-existent.

### BACKGROUND OF THE INVENTION

Historically, Traditional NFC-based access control systems have become a popular method for controlling physical access to secure areas. These systems typically use NFC-enabled cards or mobile devices to authenticate users and allow entry to restricted areas, such as corporate offices, government buildings, or industrial facilities. Despite their widespread use, these systems are often insecure due to the reliance on static identifiers, such as static UIDs (Unique Identifiers) or simple cryptographic tokens, which are vulnerable to cloning and replay attacks. In these attacks, malicious actors can replicate or replay authentication data, gaining unauthorized access to secure areas.

Existing solutions, such as Mifare-based systems, suffer from these weaknesses because they rely on static identifiers that can easily be cloned or compromised using off-the-shelf tools. These systems also lack sophisticated cryptographic mechanisms to verify the integrity and authenticity of the user's credentials. As a result, traditional NFC-based access control systems are inadequate for high-security environments where cloning resistance and replay attack prevention are critical requirements.

Another limitation of existing NFC access systems is their reliance on continuous network connectivity. Many modern systems depend on cloud-based servers or centralized databases to verify user credentials and grant access. This reliance on external networks creates vulnerabilities in environments with poor or no network access, such as remote locations, secure data centers, or disaster recovery sites. In such environments, offline functionality becomes a crucial requirement, but most existing systems lack the capability to function securely in an offline mode.

Various patents and published applications attempt to address aspects of NFC-based and cryptographic access control systems. For example, U.S. Patent Application US20230362163A1 describes a system that integrates NFC technology with FIDO2 security keys for user authentication. This patent highlights the use of out-of-band authentication in environments with intermittent connectivity. However, it primarily focuses on web-based services and is not specifically optimized for offline physical access control systems, especially those tailored to existing door and turnstile infrastructure.

U.S. Pat. No. 11,562,609B2 introduces an access control system that leverages NFC and offline functionality. While this patent acknowledges the use of offline authentication, the specific cryptographic processes and technical implementation differ significantly from the present invention. The method described lacks the focus on FIDO2's advanced cryptographic protocols and does not fully address the vulnerabilities posed by cloning and replay attacks in the physical security domain.

Another patent, U.S. Pat. No. 10,192,383B2, discloses a system for offline access control, where NFC communication is used for entry without continuous network connectivity. However, the authentication mechanisms described in this patent rely on simpler forms of credential verification and do not utilize the sophisticated public-key cryptography that is fundamental to the FIDO2 protocol. Additionally, this patent lacks the seamless integration with existing door control infrastructure, which is a key feature of the present invention.

Lastly, U.S. Pat. No. 11,184,766B1 describes an authentication system that utilizes ambient data and machine learning to continuously verify a user's identity. Although this system provides continuous authentication, it does so in the context of remote services rather than physical access control. The system relies on ambient fingerprints and other digital signals, which are impractical for offline and physical environments like secure facilities or door control systems.

Given the vulnerabilities and limitations outlined in existing technologies, there is a pressing need for a more secure, robust, and user-friendly solution for physical access control. The combination of NFC with FIDO2 cryptographic authentication presents an opportunity to overcome the shortcomings of existing NFC-based systems. By implementing public-key cryptography and challenge-response mechanisms, FIDO2 eliminates the vulnerabilities associated with static UIDs and simple tokens, providing strong protection against cloning and replay attacks.

Furthermore, environments such as remote facilities, military installations, data centers, and critical infrastructure sites often require systems that can function without network connectivity. Current solutions either rely heavily on centralized servers or lack the security features required for these high-risk environments.

### SUMMARY OF THE INVENTION

Embodiments of the present invention relates to an offline mode Near Field Communication (NFC)-based FIDO2 authentication system designed for securing physical access to doors, turnstiles, and other entry points. The system integrates NFC technology with the FIDO2 cryptographic authentication standard to provide a highly secure, password less method for controlling physical access in environments where network connectivity may be limited or unavailable. By enabling offline operation, the invention addresses the limitations of existing NFC-based access control systems, which are vulnerable to cloning, replay attacks, and network dependency.

In one embodiment, the invention comprises a FIDO2 security key, an NFC reader, and a door controller. The FIDO2 security key stores user credentials and performs cryptographic operations essential for authentication. When the security key is presented to the NFC reader, the reader initiates a challenge-response protocol by generating a cryptographic challenge, which is signed by the security key using a private key stored in its secure element. The signed response is verified by the NFC reader using a pre-stored public key, ensuring the authenticity of the user. Upon successful authentication, the NFC reader extracts a Physical Access Control (PAC) number from the security key and transmits it to the door controller, which grants or denies access based on pre-configured access profiles.

The invention operates in offline mode, allowing secure authentication without the need for continuous internet connectivity. This feature makes the system ideal for deployment in environments with unreliable or no network access, such as remote installations, high-security facilities, or industrial sites. The system is also designed to be backward compatible with existing door controllers, enabling organizations to improve their security infrastructure without requiring significant upgrades to their hardware.

In another embodiment, the invention includes a method for offline NFC-based FIDO2 authentication. The method involves presenting the FIDO2 security key to the NFC reader, generating a cryptographic challenge, signing the challenge using the private key, and verifying the signed response using the public key. Upon successful verification, the NFC reader extracts the PAC number and sends it to the door controller, which then determines whether to grant access based on stored door profiles. The method ensures that all authentication operations are performed locally, without reliance on external servers or network connectivity.

The inventive system offers several key advantages over existing NFC-based access control systems. By utilizing FIDO2's robust cryptographic protocols, the system eliminates vulnerabilities associated with static UIDs and simple cryptographic tokens, making it resistant to cloning and replay attacks. Additionally, the system provides a password less and user-friendly experience, allowing users to quickly and securely gain access without the need for complex passwords or PINs. Visual or audio indicators on the NFC reader provide immediate feedback to the user regarding authentication status.

The invention also supports scalability for large organizations, enabling bulk provisioning and management of FIDO2 security keys. This makes the system suitable for a wide range of industries, including corporate offices, government buildings, healthcare facilities, and research institutions, where secure access control is critical. By leveraging widely adopted FIDO2 standards, the system ensures future-proofing and compatibility with evolving security technologies, while offering the flexibility to adapt to various security requirements.

This summary is provided merely for purposes of summarizing some example embodiments, so as to provide a basic understanding of some aspects of the subject matter described herein. Accordingly, it will be appreciated that the above-described features are merely examples and should not be construed to narrow the scope or spirit of the subject matter described herein in any way. Other features, aspects, and advantages of the subject matter described herein will become apparent from the following detailed description and figures.

### BRIEF DESCRIPTION OF THE DRAWINGS

The prior and other objects of this invention, the various features thereof, as well as the invention itself, may be more fully understood from the following description, when read together with the accompanying drawings in which:

FIG. 1 provides a stepwise illustration of offline mode NFC-based FIDO2 authentication system for door/turnstile access control

### DETAILED DESCRIPTION OF PREFERRED EMBODIMENT(S)

The following detailed description is intended to describe aspects of the invention in sufficient detail to enable those skilled in the art to practice the invention. Other embodiments can be utilized, and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, embodiments of the invention can include a variety of combinations and/or integrations of the embodiments described herein.

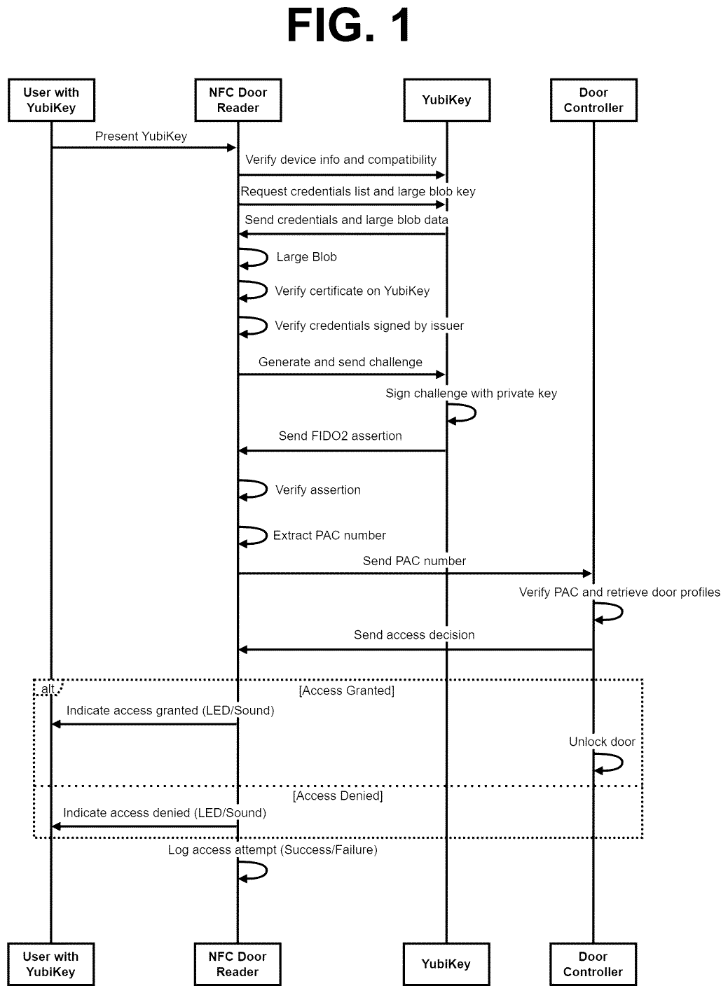

The present invention relates to an offline Near Field Communication (NFC)-based FIDO2 authentication system (FIG. 1) for door and turnstile access control, providing a secure, cryptographic solution that operates independently of continuous network connectivity. The invention is designed to solve the inherent security vulnerabilities in traditional NFC-based systems, which rely on static identifiers and are susceptible to cloning and replay attacks. By leveraging FIDO2 cryptographic security protocols, the system enables robust offline authentication suitable for environments with limited or no network access, such as high-security facilities or remote locations.

In a preferred embodiment of the present invention, the system comprises three main components: a FIDO2 security key, an NFC reader, and a door controller. The FIDO2 security key stores user credentials in a secure element and performs cryptographic operations essential for authentication. In this embodiment, the FIDO2 security key communicates with the NFC reader via NFC technology, allowing for seamless and secure exchange of credential data. A key advantage of this system is its ability to perform offline operations, ensuring that access control functions even when network connectivity is unavailable.

The NFC reader serves as an intermediary between the FIDO2 security key and the door controller. Upon receiving the credential data from the FIDO2 security key, the NFC reader generates a cryptographic challenge, which is transmitted back to the security key. The FIDO2 security key then uses its private key to sign the challenge and sends the signed response to the NFC reader. The reader verifies this response using a pre-stored public key, ensuring the authenticity of the user.

Upon successful verification, the NFC reader extracts a physical access control (PAC) number from the FIDO2 security key. This PAC number is then transmitted to the door controller, which retrieves the corresponding door profiles and grants or denies access based on pre-configured policies. The entire authentication process is conducted locally between the NFC reader and the FIDO2 security key, enabling offline mode operation.

In the same embodiment, the door controller is a critical component of the system, responsible for applying access control policies based on the PAC number. The door controller interacts with the door lock mechanism, granting or denying physical access based on the authentication result received from the NFC reader. This component ensures backward compatibility with existing door infrastructure, minimizing the need for costly upgrades while enhancing security. The system allows for the configuration of customizable access policies, such as time-based rules or individual user permissions, enhancing the flexibility of access control management.

The NFC reader further includes an indicator mechanism, such as LED lights or sound, to provide visual or audio feedback to the user regarding the success or failure of authentication. This improves the user experience, allowing for seamless and efficient interaction with the system.

In another embodiment, the FIDO2 security key used in the system can be a YubiKey with NFC capability, designed to store elliptic-curve cryptographic keys in a secure element. The YubiKey performs FIDO2 challenge-response operations, ensuring that authentication is both unclonable and non-replayable. The security key communicates with the NFC reader using large blob storage, containing encrypted user credentials, certificates, and access tokens, ensuring the confidentiality and integrity of the transmitted data.

The NFC reader in this embodiment is equipped with a large blob decryption module, which is capable of decrypting the large blob data stored in the FIDO2 security key. This module verifies the credential certificates contained in the large blob, ensuring that they are signed by an authorized credential issuer. Once the credentials are verified, the reader proceeds with generating a cryptographic challenge, as described in the previous embodiment.

In yet another embodiment, the method for offline NFC-based FIDO2 authentication involves several critical steps. First, the user presents their FIDO2 security key to the NFC reader. The reader verifies the compatibility of the key and generates a cryptographic challenge. The FIDO2 security key signs this challenge using its private key, and the signed response is sent back to the NFC reader. The reader verifies the signed response using the pre-stored public key and, upon successful verification, extracts the PAC number. This PAC number is transmitted to the door controller, which applies access control policies to determine whether access should be granted or denied.

In this embodiment, the system supports offline mode functionality, where the authentication process is performed locally without requiring constant network connectivity. This feature makes the system particularly suitable for environments where internet access is unreliable or unavailable. Additionally, the system allows for manual configuration of access policies, or in some cases, periodic updates through occasional network synchronization.

In yet another embodiment, the door controller can be configured to support more complex access control schemes. For instance, time-based access rules can be established, wherein certain doors are accessible only during specific time windows. Similarly, the door controller can store door profiles for individual users or groups of users, allowing for greater flexibility in controlling access.

Furthermore, the system can be designed to handle high-security environments by integrating additional security layers, such as biometric verification or multi-factor authentication. This flexibility allows the system to be adapted to various use cases, including corporate offices, government buildings, and military installations, where stringent access control is essential.

In a further embodiment, the system offers significant security advantages over traditional NFC-based access control systems. Conventional NFC systems often rely on static UIDs or simple cryptographic challenges, which are vulnerable to cloning and replay attacks. The integration of FIDO2 protocols into the system ensures that each authentication process generates a unique cryptographic challenge that cannot be replicated. Moreover, the system is resistant to relay attacks due to the short range of NFC communication and the cryptographic operations that underpin the FIDO2 standard.

Additionally, the system offers future-proofing through its use of widely supported FIDO2 standards, ensuring compatibility with evolving security technologies. The use of a single authenticator, such as a YubiKey, for both logical and physical access simplifies the management of user credentials, reducing the need for multiple authentication tokens. This unified identity management improves user experience while lowering operational costs.

In a final embodiment, the system is designed to be scalable for large enterprises, supporting bulk provisioning of FIDO2 security keys and centralized management of access control policies. An administrative portal may be developed to allow for the efficient issuance and revocation of FIDO2 credentials, making the system suitable for deployment in environments with a large number of users.

The system architecture supports a modular design, allowing for the integration of additional security features or customization based on the specific needs of the deploying organization. This flexibility ensures that the system can be adapted to meet the demands of a wide range of industries, including healthcare, financial institutions, and research facilities.

The offline mode NFC-based FIDO2 authentication system for door and turnstile access control represents a significant advancement in physical security technologies. By utilizing FIDO2 cryptographic protocols in an offline environment, the system addresses longstanding vulnerabilities in traditional NFC-based access control systems. The invention provides a seamless and secure solution for environments with limited network connectivity, offering enhanced security, compatibility with existing infrastructure, and an improved user experience.

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular examples of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### ABBREVIATIONS

FIDO2—Fast Identity Online 2
LED—Light Emitting Diode
NFC—Near Field Communication
PAC—Physical Access Control
UID—Unique Identifier

1. An offline mode Near Field Communication (NFC)-based authentication system for door or turnstile access control, comprising:
a. a FIDO2 security key configured to store user credentials and perform cryptographic operations, the key including:
i. a secure element configured to store user credentials, cryptographic key pairs, and access policies;
ii. an NFC communication module configured to communicate with an NFC reader in an offline mode;
iii. a cryptographic module configured to perform challenge-response operations using elliptic-curve cryptography; and
iv. large blob storage containing encrypted user credentials, certificates, and access tokens;
b. an NFC reader configured to communicate with the FIDO2 security key, the reader comprising:
i. a communication module for interacting with the FIDO2 security key via NFC;
ii. a cryptographic challenge generator for creating and sending cryptographic challenges to the FIDO2 security key;
iii. a verification module for decrypting and verifying the signed challenge response using a pre-stored public key;
iv. an interface for sending a physical access control (PAC) number to a door controller; and
v. an operational mode that allows offline functionality without requiring continuous network connectivity;
c. a door controller operatively connected to the NFC reader, the door controller being configured to control a door lock mechanism based on authentication results;
d. wherein the NFC reader performs the following operations:
i. receives credential data from the FIDO2 security key via NFC communication;
ii. generates a cryptographic challenge and transmits it to the FIDO2 security key;
iii. receives a signed response from the FIDO2 security key, the response being generated by the FIDO2 security key using a private key;
iv. verifies the signed response using a pre-stored public key to authenticate the user;
v. extracts a physical access control (PAC) number upon successful authentication; and
vi. transmits the PAC number to the door controller to grant or deny access;
e. wherein the system operates without continuous network connectivity, providing offline authentication.

2. The system of claim 1, wherein the FIDO2 security key is a YubiKey with NFC capability, configured to store elliptic-curve cryptographic keys in a secure element and perform FIDO2 challenge-response operations.

3. The system of claim 1, wherein the NFC reader further comprises a decryption module to decrypt and verify large blob data stored in the FIDO2 security key, containing encrypted access credentials and certificates.

4. The system of claim 1, wherein the door controller is configured to retrieve and apply door profiles based on the PAC number, allowing for customizable access control policies.

5. The system of claim 1, wherein the NFC reader and door controller are configured to operate in environments with limited or no internet connectivity, ensuring continued operation during network outages.

6. The system of claim 1, wherein the NFC reader provides a visual or audio indicator, such as LED lights or sounds, to signal the authentication result to the user.

7. The system of claim 1, wherein the FIDO2 security key includes a tamper-resistant secure element to protect stored credentials and cryptographic keys from physical attacks.

8. The system of claim 1, wherein the NFC reader performs mutual authentication with the FIDO2 security key to ensure both the reader and the key are legitimate devices.

9. The system of claim 1, wherein the door controller includes a logging module to record access events, including successful and failed authentication attempts, for audit and security purposes.

10. The system of claim 1, wherein the NFC reader is equipped with a fallback mechanism to allow temporary access using alternative authentication methods in case of FIDO2 key failure.

11. A method for offline NFC-based FIDO2 authentication for door or turnstile access control, comprising the steps of:
a. presenting a FIDO2 security key to an NFC reader;
b. the NFC reader verifying the compatibility of the FIDO2 security key;
c. generating, by the NFC reader, a cryptographic challenge and sending it to the FIDO2 security key;
d. signing the cryptographic challenge, by the FIDO2 security key, using a private key stored in the FIDO2 security key;
e. receiving, by the NFC reader, the signed response from the FIDO2 security key;
f. verifying the signed response, by the NFC reader, using a pre-stored public key;
g. extracting a physical access control (PAC) number from the FIDO2 security key upon successful authentication;
h. transmitting the PAC number to a door controller;
i. the door controller verifying the PAC number and granting or denying access based on door profiles stored in the door controller;
j. wherein the method is performed in an offline mode without requiring network connectivity.

12. The method of claim 11, wherein the FIDO2 security key stores a public key for verifying the authenticity of credential signatures provided by an authorized credential issuer.

13. The method of claim 11, wherein the step of transmitting the PAC number to the door controller includes verifying the access rights based on local security policies stored within the door controller.

14. The method of claim 11, further comprising the step of periodically updating the access control policies in the door controller via manual configuration or occasional network synchronization.

15. The method of claim 11, wherein the door profiles include time-based access rules, allowing or denying access based on predefined schedules.

16. The method of claim 11, further comprising the step of performing mutual authentication between the NFC reader and the FIDO2 security key before initiating the cryptographic challenge.

17. The method of claim 11, wherein the NFC reader periodically updates its stored public keys and access policies from a central management system during scheduled network connectivity windows.

18. The method of claim 11, further comprising the step of encrypting the PAC number before transmitting it to the door controller to enhance security during communication.

19. The method of claim 11, wherein the door controller generates and stores an audit log entry for each access attempt, including the time, date, and result of the authentication process.
